(19) United States
(12) Patent Application Publication
(10) Pub. No.: US 2021/0023764 A1
(43) Pub. Date: Jan. 28, 2021

(54) THREE DIMENSIONALLY SHAPED BIOFABRICATED MATERIALS AND METHODS OF MANUFACTURE

(71) Applicant: Modern Meadow, Inc., Nutley, NJ (US)

(72) Inventors: Nicholas John BABIN, Jersey City, NJ (US); Kevin SPARKS, Scituate, MA (US); Stephen SPINELLA, Brooklyn, NY (US); Brendan Patrick PURCELL, Philadelphia, PA (US)

(21) Appl. No.: 16/978,545

(22) PCT Filed: Mar. 5, 2019
(86) PCT No.: PCT/US19/20768

§ 371 Date: Sep. 4, 2020

Related U.S. Application Data
(60) Provisional application No. 62/638,670, filed on Mar. 5, 2018.

(51) Int. Cl. B29C 51/00; C08K 5/3415; C08J 5/18; B29C 45/00; B29C 51/10

(52) U.S. Cl. CPC B29C 51/002; C08K 5/3415; C08J 5/18; B29C 45/0001; B33Y 80/00; C08K 2201/014; C08J 2367/04; B29K 2089/00; B29C 51/10

(57) ABSTRACT

Described herein are three dimensionally shaped biofabricated materials and method of making three dimensionally shaped biofabricated materials.

### CROSS REFERENCE TO RELATED APPLICATIONS

The methods and materials (e.g., biofabricated leather materials) described herein may be used with or may include features described in any of the following patent and pending applications, and/or may be related to one or more of them. Each of the following patents and pending applications are herein incorporated by reference in their entirety: U.S. patent application Ser. No. 13/853,001, titled “ENGINEERED LEATHER AND METHODS OF MANUFACTURE THEREOF” and filed on Mar. 28, 2013; U.S. patent application Ser. No. 14/967,173, titled “ENGINEERED LEATHER AND METHODS OF MANUFACTURE THEREOF” and filed on Dec. 11, 2015; PCT Patent Application No. PCT/US2015/058794, titled “REINFORCED ENGINEERED BIOMATERIALS AND METHODS OF MANUFACTURE THEREOF” and filed on Nov. 3, 2015; U.S. patent application Ser. No. 15/433,777, titled “BIOFABRICATED MATERIAL CONTAINING COLLAGEN FIBRILS” and filed on Feb. 15, 2017; and U.S. patent application Ser. No. 15/433,676, titled “COMPOSITE BIOFABRICATED MATERIAL” and filed on Feb. 15, 2017.

### STATEMENT REGARDING INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

### Field of the Disclosure

This invention relates to shaped biofabricated leather materials that mimic naturally-derived materials. In particular, this invention is directed towards three dimensionally shaped biofabricated leather materials formed by a vacuum forming process, an injection molding process and a thermoforming process.

### Description of the Related Art

Leather is used in a vast variety of applications, including furniture upholstery, clothing, shoes, luggage, handbag and accessories, and automotive applications. Currently, skins of animals are used as raw materials for natural leather. However, skins from livestock pose environmental concerns because raising livestock requires enormous amounts of feed, pastureland, water, and fossil fuel. Livestock also produces significant pollution for the air and waterways. In addition, use of animal skins to produce leather is objectionable to socially conscious individuals. The global leather industry slaughters more than a billion animals per year. Most of the leather comes from countries with no animal welfare laws or have laws that go largely or completely unenforced. Leather produced without killing animals would have tremendous fashion novelty and appeal.

Many attempts have been made throughout history to imitate leather with a variety of synthetic materials. As alluded to earlier, there is a strong demand for alternatives to leather as leather production involves the slaughter of animals, which carries with it a large environmental impact to raise and process. The increasing demand for leather products also promotes stockyard practices and factory farming where mistreatment of animals has been documented. As a result, the quality and availability of leather continues to decrease as planetary resources become ever more strained.

Attempts to create synthetic leather have all come up short in reproducing leather's unique set of properties. Examples of synthetic leather materials include Clarino, Naugahyde, Corfam, and Alcantara, amongst others. They are made of various chemical and polymer ingredients, including polyvinyl chloride, polyurethane, nitrocellulose coated cotton cloth, polyester, or other natural cloth or fiber materials coated with a synthetic polymer. These materials are assembled using a variety of techniques, often drawing from chemical and textile production approaches, including non-woven and advanced spinning processes. While many of these materials have found use in footwear, upholstery, and apparel applications, they have fallen short for luxury application, as they cannot match the breathability, performance, handfeel, or aesthetic properties that make leather so unique and beloved. To date, no alternative leather-like materials have been made from collagen or collagen-like proteins, and therefore these materials lack the chemical composition and structure of a collagen network that produces a leather aesthetic. The abundance of acidic and basic amino acid side groups along the collagen polypeptide chain, along with its organization into a strong yet porous, fibrous architecture allow modification through tanning processes and produces the desirable strength, softness and aesthetic of leather.

Biofabricated leather may be useful in many products, some of which require the ability to shape the biofabricated leather and retain the shape. As used herein, the term “shape” means a three dimensional structure with a length, width and height and/or a retained radius of curvature along at least one aspect of a product. Examples of such products include, but are not limited to shoes, sneakers, cantenes, decanters and the like.

Current leather processes for making these products include cutting shapes out of sheets of leather, which results in incomplete use of the leather and leather waste. There is a need for a more efficient process of forming shaped biofabricated leather products while minimizing waste. Co-pending U.S. Patent Application No. 62/533,950 and Ser. No. 15/713,300 each form biofabricated leather by various processes. The biofabricated leather is not shaped.

U.S. Patent Application Publication No. 2009/0226557 teaches the use of thermoplastic compositions containing denatured collagen pellets to create shaped solid articles by various processes. The compositions include plasticizers. Despite the teaching, there is a continuing need a more efficient process of forming shaped biofabricated leather products while minimizing waste.

### SUMMARY OF THE DISCLOSURE

In general, described herein are shaped, biofabricated leather materials and methods of forming them from fibrillated non-human collagen that is tanned, dehydrated and lubricated or fatliquored. The resulting biofabricated material may be used in any way that native leather is used, and may be grossly similar in appearance and feel to real leather, while having additional features that differentiate it from ordinary leather. For example, the biofabricated leather material is shaped such that it can be useful for shaped articles, such as footwear, balls, handbags, wallets and the like, and time and waste are minimized.

The engineered leather materials described herein may also be referred to as biofabricated leather materials because they are fabricated in vitro, in contrast to native or natural leather which is derived from in vivo grown animal hides.

For example, a biofabricated leather material may be a fibrillated, tanned (e.g., cross-linked) and fatliquored (lubricated) collagen having a thickness, wherein a water content of the material is 20% or less by weight (e.g., and wherein a lubricant content of the material is 1% or more by weight; and wherein the material comprises a network of collagen fibrils having a fibril density of between 5 and 500 mg/cc.

For example, a biofabricated leather material may be a fibrillated, tanned (e.g., cross-linked) and lubricated collagen, wherein the material comprises a thickness of between about 0.05 mm to 20 mm, further wherein the water content of the material may be 20% or less by weight and wherein a lubricant (e.g., fat, oil, other materials such as a polymer that allows movement of fibrils in dehydrated leather material) content of the material may be 1% (e.g., 10%, 15%, 20%, 25%, 30%, 35%, 40%, 45%, 50%, 55%, 60%, etc., between a lower value of 15%, 20%, 25%, 30%, 35%, 40%, 45%, etc. and an upper value of 20%, 25%, 30%, 35%, 40%, 45%, 50%, 55%, 60%, etc. where the lower value is always less than the upper value) or more by weight; and wherein the material comprises a network of unbundled collagen fibrils having a fibril density of between 5 and 500 mg/cc.

In general, the water content of the biofabricated leather materials described herein may be less than a predetermined maximum percentage (e.g., less than 20%, 15%, 10%, etc.) and the lubricant content may be (by percent weight) greater than a predetermined minimum percentage (e.g., greater than 10%, 15%, 20%, 25%, 30%, 35%, 40%, 45%, 50%, 55%, 60%, etc., or between a lower value of 10%, 15%, 20%, 25%, 30%, 35%, 40%, 45%, etc. and an upper value of 20%, 25%, 30%, 35%, 40%, 45%, 50%, 55%, 60%, etc. where the lower value is always less than the upper value).

Any of the biofabricated leathers described herein may be fatliquored to introduce a lubricant, as mentioned above. In general, the lubricant is a material such as a fat, oil or materials such as a polymer that allows movement of fibrils in dehydrated leather material that is introduced to coat the collagen fibrils. Suitable lubricants include, but are not limited to, polyurethanes, acrylic acid based polymers, marine-like oils, sulphonated marine-like oils, fish oils, vegetable oils, castor oils, olive oils, and the like.

A biofabricated leather material may comprise a tanned fibrillated collagen material having characteristics including: a thickness of between 0.05 mm to 20 mm; a water content of less than 20% by weight; and a network of collagen or collagen-like fibrils, wherein the fibrils have a fibril density of between 5 and 500 mg/cc.

A biofabricated leather material may include a tanned fibrillated collagen hydrogel material having characteristics comprising: a thickness of between 0.5 mm to 20 mm; a water content of less than 20% by weight; and a porous network of collagen or collagen-like fibrils, wherein the fibrils have a fibril density of between 5 and 500 mg/cc uniformly throughout the entire thickness.

Any of the biofabricated leather materials described herein may include less than 10% (e.g., <7%, less than 5%, less than 4%, less than 3%, less than 2%, etc.) of a tanning agent (e.g., collagen cross-linker) in the biofabricated leather.

In general, the fibrillated collagen within the biofabricated leather volume and thickness may lack any or any substantial amount of secondary structure. For example, the biofabricated leather material described herein may not be bundled (may be unbundled). The fibrils may have a fibril diameter of between 1 nm and 1 μm, and/or a fibril length between 100 nm and 1 mm throughout the entire thickness. The biofabricated leather may be able to elongate up to 300% from a relaxed state length. The biofabricated leather may have an elastic modulus of at least 1 kPa. The biofabricated leather may have an elastic modulus of between 1 kPa and 100 MPa. The biofabricated leather may have a tensile strength of at least 1 MPa. The biofabricated leather may have a tensile strength of between 1 MPa and 100 MPa.

As mentioned, any of the biofabricated leather materials described herein may include a lubricant (e.g., fat and/or oil or other hydrophobic material). The percentage of lubricant in the material may be between about 10% and 60% (e.g., between a lower value of 10%, 15%, 20%, 25%, 30%, 35%, 40%, 45%, etc. and an upper value of 20%, 25%, 30%, 35%, 40%, 45%, 50%, 55%, 60%, etc. where the lower value is always less than the upper value).

Also described herein are methods of biofabricating a leather from fibrils. A method of forming a biofabricated leather material may generally include tanning, dehydrating, and fatliquoring a fibrillated collagen. The tanning step typically refers to any appropriate method of stabilizing the fibrillated collagen. Tanning may include adding a tanning agent (e.g., chemical or physical cross-linker that reacts with collagen to stabilize the collagen structure) before or after fibrillating the collagen and/or when dehydrating the water swollen collagen fibrils. A crosslinked network of collagen (e.g., hydrogel) may be formed as the collagen is fibrillated, or it may form a network after fibrillation; in some variations, the process of fibrillating the collagen also forms a hydrogel.

A dehydration step typically refers to any appropriate method of removing water from the collagen fibrils (evaporation, solvent exchange, syntan treatment, filtration, etc). It is well known that there are several forms of water in collagen based materials such as leather including free, bound and tightly bound water, and a dehydration step can remove any or all of these forms of water. A fatliquoring step typically refers to any appropriate method to control fibril-fibril bonding during dehydration and allow fibrils to move relative to each other. It is well known in the art of leather tanning that fatliquoring fibrils (and collagen fibers and fiber bundles) is important to produce a soft leather. Fatliquoring may include removing bound water with solvents, adding commercially available fatliquoring oils and polymers, as well as adding any appropriate molecule that lubricates the fibril network to produce a soft material.

A method of forming biofabricated leather from collagen fibrils may include the steps of tanning, dehydrating and fatliquoring in any order. For example, the fibrils may be tanned with a crosslinking agent such as glutaraldehyde, then coated with a fatliquor such as a sulfited oil, and then dehydrated through filtration to form a fibrillated collagen leather. Alternatively, following fibril tanning, the fibrils can be dehydrated through a solvent exchange with acetone, followed by fatliquoring with a sulfited oil before evaporating away the solvent to form a fibrillated collagen leather. In addition, the incorporation of chemical or physical crosslinks between fibrils (to impart material strength) can be accomplished at any point during the process. For example, a solid fibrillated collagen hydrogel can be formed, then this fibril network can be dehydrated through a solvent exchange with acetone, followed by fatliquoring with a sulfited oil before evaporating away the solvent to form a fibrillated collagen leather. Alternatively, collagen fibrils can be tanned and fatliquored in suspension before forming a network between fibrils during dehydration or through the addition of a binding agent to the suspension or to the dehydrated material.

For example, a method of forming a biofabricated leather material may include: inducing fibrillation of collagen in a solution and creating a fibrillated collagen hydrogel; tanning (e.g., cross-linking) and dehydrating the fibrillated collagen hydrogel to obtain a fibrillated collagen leather, and incorporating at least one lubricating fat or oil into the fibrillated collagen leather.

For example, a method of forming a biofabricated leather material may include: inducing fibrillation of collagen in a solution; tanning (e.g., cross-linking) and dehydrating the fibrillated collagen to obtain a fibrillated collagen network, and incorporating at least one lubricating fat or oil to obtain the fibrillated collagen leather.

For example a method of biofabricating a leather from fibrils may include: inducing fibrillation of collagen or collagen-like proteins in a solution to obtain a fibrillated collagen hydrogel; tanning the fibrillated collagen hydrogel to obtain a fibrillated collagen hydrogel leather; and incorporating at least one lubricating oil into the fibrillated collagen hydrogel leather. The order of the steps for forming biofabricated leather may be varied. For example, the tanning agent and/or the lubricant may be incorporated in the solution prior to fibrillating the collagen, etc.

The collagen or collagen-like proteins, generally, may be obtained through extraction of collagen from any animal source. In a particular embodiment, the extracted natural collagen is a non-human animal. Examples of non-human animals include bovine, pig, kangaroo, sheep, alligator, ostrich, dinosaur, elephant, crocodile, mammoth, antelope, bear, beaver, bison, boar, camel, caribou, cat, cattle, deer, dog, elk, fox, giraffe, goat, hare, horse, ibex, lion, llama, lynx, mink, moose, oxen, peccary, rabbit, seal, squirrel, tiger, whale, wolf, yak, zebra, turtle, snake, frog, toad, salamander, newt, chicken, duck, emu, goose, grouse, pheasant, pigeon, quail, turkey, fish (e.g., anchovy, bass, catfish, carp, cod, eel, flounder, fugu, grouper, haddock, halibut, herring, mackerel, mahi mahi, manta ray, marlin, orange roughy, perch, pike, pollock, salmon, sardine, shark, snapper, sole, stingray, swordfish, tilapia, trout, tuna, walleye) or a combination thereof.

In general, the engineered leather may be patterned. For example, the engineered leather may be patterned after a skin pattern of an animal selected from antelope, bear, beaver, bison, boar, camel, caribou, cat, cattle, deer, dog, ostrich, elephant, mammoth, elk, fox, giraffe, goat, hare, horse, ibex, kangaroo, lion, llama, lynx, mink, moose, oxen, peccary, pig, rabbit, seal, sheep, squirrel, tiger, whale, wolf, yak, zebra, turtle, snake, crocodile, alligator, dinosaur, frog, toad, salamander, newt, chicken, duck, emu, goose, grouse, ostrich, pheasant, pigeon, quail, turkey, anchovy, bass, catfish, carp, cod, eel, flounder, fugu, grouper, haddock, halibut, herring, mackerel, mahi mahi, manta ray, marlin, orange roughy, perch, pike, pollock, salmon, sardine, shark, snapper, sole, stingray, swordfish, tilapia, trout, tuna, walleye, and a combination thereof. The pattern may be a skin pattern of a fantasy animal selected from dragon, unicorn, griffin, siren, phoenix, sphinx, Cyclops, satyr, Medusa, Pegasus, Cerberus, Typhoeus, gorgon, Charybdis, empusa, chimera, Minotaur, Cetus, hydra, centaur, fairy, mermaid, Loch Ness monster, Sasquatch, thunderbird, yeti, chupacabra, and a combination thereof.

Alternatively, the collagen or collagen-like proteins may be obtained from a non-animal hide source, e.g., obtained through recombinant DNA techniques, cell culture techniques, chemical peptide synthesis, etc. Any of these methods may include polymerizing the collagen or collagen-like proteins into dimers, trimers, and higher order oligomers prior to fibrillation, and/or chemically modifying the collagen or collagen-like proteins to promote crosslinking between the collagen or collagen-like proteins. Any of these methods may include functionalizing the collagen or collagen-like proteins with one or a combination of chromium, amine, carboxylic acid, sulfate, sulfite, sulfonate, aldehyde, hydrazide, sulfhydryl, diazirine, aryl, azide, acrylate, epoxide, or phenol group.

Inducing fibrillation may include adding a salt or a combination of salts, for example, the salt or combination of salts may include: Na₃PO₄, K₃PO₄, KCl, and NaCl, the salt concentration of each salt may be between 10 mM to 5M, etc.

In general, inducing fibrillation may comprise adjusting the pH with an acid or a base, adding a nucleating agent (e.g., a branched collagen microgel), wherein the nucleating agent has a concentration between 1 mM to 100 mM, etc. The fibrillated collagen may be stabilized with a chromium compound, an aldehyde compound, or vegetable tannins, or any other tanning agent. For example, the fibrillated collagen may be stabilized with a chromium compound, an aldehyde compound, or vegetable tannins, wherein the chromium, aldehyde, or vegetable tannin compounds having a concentration of between 1 mM to 100 mM.

Any of these methods may include adjusting the water content of the fibrillated collagen to 20% or less by weight to obtain the fibrillated collagen hydrogel leather. For example, the fibrillated collagen material may be dehydrated. Any of these methods may also include dyeing and/or applying a surface finish to the fibrillated collagen leather.

To make three dimensionally shaped biofabricated leather products, a solution as described above and according to co-pending U.S. Patent Application No. 62/533,950 and Ser. No. 15/713,300 which are hereby incorporated by reference may be utilized. The concentrated solution contains collagen, at least one cross-linker, and a hydrophobic material such as an oil or fatliquor. The concentrated solution is fibrillated, yielding a somewhat viscous solution. The amount of collagen in the concentrated solution may range from about 5 to about 30 percent by weight of the solution.

The shape of the three dimensionally shaped product is determined by a mold having a cavity. In one embodiment, the mold contains 2 parts, a female mold and a male mold. The cavity in the mold may be made to any desired shape including but not limited to a sphere, a cylinder, a cone, a cube, a tetrahedron, a cuboid, and a triangular prism having surfaces of a shape including but not limited to round, curved, square, and elliptical. The mold may be made from any material known in the art including but not limited to polyethylene, polyethylene terephthalate, polypropylene, polycarbonate, aluminum, fiber glass and stainless steel. The mold may be fabricated according to a variety of methods known in the art to be appropriate at least in the context of the selected material including but not limited to additive manufacturing, subtractive manufacturing, casting, molding, forming, or a combination thereof. Additive manufacturing techniques include but are not limited to three-dimensional printing and fused deposition modeling. The mold may be heated to activate a chemical such as a crosslinker or resin or to melt/maintain the liquid state of a polymer additive. The temperature of the mold may range from about 20° C. to 150° C. The female mold contains an outer surface and inner bottom and side surfaces. The surfaces of the female mold may also be made of a porous material that enables water to be removed from the solution via vacuum. The length of time required to achieve sufficient dehydration is dependent upon the concentration of the collagen solution used and may range from 30 seconds to 1 hour. The porous material comprising the surfaces of the female mold may be a filter or, similarly, a mesh of a size to maintain the integrity of the solid collagen material under vacuum while allowing dehydration of the collagen (e.g. stainless steel mesh; size 200 mesh or greater, or wherein the opening size is 74 microns or smaller). The male mold has outer bottom, side surfaces and is designed to be inserted to a set clearance inside the female mold, forming a void.

The method of making shaped biofabricated leather materials includes providing the 2 part mold described above, providing a collagen solution, dispensing a volume of the collagen solution to the inner bottom surface of the female mold to partially fill the female mold, inserting the male mold inside the female mold, such that the outer bottom of the male mold contacts the collagen solution and a void of pre-determined dimensions is formed between the outer side surface of the male mold and the inner side surface of the female mold, dispensing collagen solution into the void, applying vacuum to remove water from the solution and continuing to add collagen solution in volumetric increments and pull vacuum until the desired height of the side surface of the shaped biofabricated leather material is reached. In an aspect of the embodiment, and dependent on the dimensions of the void created between the female mold and the male mold, partially filled is defined as being a thickness between approximately 1/16 inch and 2 inches of collagen solution, as indicated by a measurement tool. Aspects of the above are understood in the art, as evidenced by U.S. Pat. No. 6,051,249 A, which is incorporated herein by reference.

In a second embodiment, the mold contains 2 parts, a left mold and a right mold. The molds are tooled to have a cavity having surfaces in any desired shape including but not limited to round, curved, square and elliptical. The mold may be made from any material known in the art including but not limited to polyethylene, polyethylene terephthalate, polypropylene, polycarbonate, aluminum, fiber glass and stainless steel. The left mold contains an outer surface and a concave inner surface. The right mold contains an outer surface and a convex inner surface with a port extending from the outer surface to the inner surface. The port is connected to a means for injecting collagen into the mold as is typical of techniques including but not limited to injection molding. Examples for means of injecting collagen include but are not limited to gear pumps (e.g. Zenith Pumps) and extruders (e.g. Thermo Fisher Scientific Twin-screw Extruders). Aspects of the above are understood in the art, as evidenced by U.S. Pat. No. 6,773,713 B2, which is incorporated herein by reference.

Another method of making shaped biofabricated leather material includes providing the 2 part mold described above, placing the left and right molds together such that the inner surfaces are adjacent, providing a heated solution of concentrated collagen and a thermoplastic polymer, providing a means for injecting collagen through the port on the right mold and injecting the collagen solution via the port into the mold until the mold is full. The mold is then cooled and opened to release the shaped biofabricated leather material. Suitable thermoplastic polymers have melting temperatures in the range of about 40° C. to about 80° C., ensuring the integrity of the collagen, and include but are not limited to polycaprolactone. In an aspect of the embodiment, the amount of thermoplastic polymer used in the recombinant or purified collagen solution may range from 10% to 50% based on the total weight of the composition.

As is understood in the art, appropriate means for releasing the shaped biofabricated leather material from the mold may be utilized. Such means include the application of release coatings, such as silicon or oil based solution, or the use of release or ejection pins in the mold.

In a third embodiment, shaped biofabricated leather material are made utilizing a thermoforming process. A concentrated collagen solution is blended with melted polycaprolactone at 60° C. to form a viscous mixture, or paste. The warm viscous mixture is distributed on a surface to a desired thickness. The viscous mixture is dried and cooled into a sheet that can be thermoformed. In another aspect of the embodiment, the warm viscous mixture may be poured into a mold of a desired shape while vacuum is applied in order to remove water and dry and cool the viscous mixture into a sheet that can be thermoformed. In another aspect of the embodiment, the formation of the sheet to a mold of a desired shape is done by heating the plastic sheet to a pliable temperature for example from about 35° C. to about 60° C., shaping it to the mold using vacuum pressure, air pressure or a combination of both. In each aspect of the embodiment, once the material has been formed to the mold, it's cooled and removed from the mold, retaining its final shape. The thermoforming machines may be purchased from companies such as Formech Inc and Maac Machinary. Aspects of the above are understood in the art, as evidenced by U.S. Pat. No. 6,051,249 A, which are incorporated herein by reference.

### BRIEF DESCRIPTION OF THE DRAWINGS

FIG. 1 is a perspective view drawing of a female mold and a male mold of the present invention for vacuum forming.

FIG. 2 is a top view of the female and male mold of the vacuum forming invention, showing cross section line AA.

FIG. 3 is a cross sectional view of the female and male mold taken along line AA filled with biofabricated collagen concentrate.

FIG. 4 is a perspective view drawing of the female mold of the vacuum forming invention.

FIG. 5 is a perspective view drawing of the male mold of the vacuum forming invention.

### DETAILED DESCRIPTION

Described herein are shaped biofabricated leather materials that are made through a shaping process including vacuum forming, injection molding and thermoforming. These biofabricated materials have distinct retained shapes otherwise not available in biofabricated leather. Also described herein are methods for making shaped biofabricated leather materials.

Because the starting materials for biofabrication of engineered leather materials, described herein, can be controlled, the resulting product may be formed with the end product in mind (e.g. materials for shoe versus material for apparel).

These end products include but are not limited to automotive upholstery, home and office furniture, sports equipment such as gloves and balls, clothing, fashion accessories such as wallets, belts, and bags, and footwear.

In general, the biofabricated fibrillated collagen hydrogel-derived leathers described herein are formed from solutions of collagen that are induced to self-assemble into collagen fibrils. The collagen fibrils, unlike endogenous collagen fibrils, are not assembled into highly-ordered structures (e.g., bundles of fibers), but remain somewhat disordered, more particularly unbundled fibrils. When assembled in vivo, collagen fibrils are typically aligned laterally to form bundles having a higher order of structure and an appropriate toughness. This is true, for example, in micron-sized collagen fibers found in skin. A characteristic feature of native collagen fibrils is their banded structure. The diameter of the native fibril changes slightly along the length, with a highly reproducible D-band repeat of approximately 67 nm. In some of the methods described herein, collagen fibrils may be unbanded and unbundled or may be banded and unbundled. The collagen fibrils may be randomly oriented (e.g., un-oriented or not oriented in any particular direction or axis).

The starting material used to form the shaped biofabricated leather material as described herein may include any appropriate non-human collagen source. Various forms of collagen are found throughout the animal kingdom. The collagen used herein may be obtained from animal sources, including both vertebrates and invertebrates, or from synthetic sources. Collagen may also be sourced from byproducts of existing animal processing. Collagen obtained from animal sources may be isolated using standard laboratory techniques known in the art. (Example: Silva et. Al., Marine Origin Collagens and its Potential Applications, Mar. Drugs, 2014 Dec. 12(12); 5881-5901). One major benefit of the biofabricated leather materials and methods for forming them described herein is that collagen may be obtained from sources that do not require killing of an animal. For instance, collagen may also be obtained via recombinant DNA techniques. Constructs encoding non-human collagen may be introduced into host organisms to produce non-human collagen. For instance, collagen may also be produced with yeast, such as Hansenula polymorpha, Saccharomyces cerevisiae, Pichia pastoris and the like as the host. Further, in recent years, bacterial genomes have been identified that provide the signature (Gly-Xaa-Yaa)n repeating amino acid sequence that is characteristic of triple helix collagen. For example, gram positive bacterium Streptococcus pyogenes contains two collagen-like proteins, Scl1 and Scl2 that now have well characterized structure and functional properties. Thus, it would be possible to obtain constructs in recombinant E. Coli systems with various sequence modifications of either Scl1 or Scl2 for establishing large scale production methods. Collagen may also be obtained through standard peptide synthesis techniques. Collagen obtained from any of the techniques mentioned may be further polymerized. Collagen dimers and trimers are formed from self-association of collagen monomers in solution.

As an initial step in the formation of the collagen materials described herein, the starting collagen material may be placed in solution and fibrillated. Collagen fibrillation may be induced through the introduction of salts to the collagen solution. The addition of a salt or a combination of salts such as sodium phosphate, potassium phosphate, potassium chloride, and sodium chloride to the collagen solution may change the ionic strength of the collagen solution. Collagen fibrillation may occur as a result of increasing electrostatic interactions, through greater hydrogen bonding, Van der Waals interactions, and covalent bonding. Suitable salt concentrations may range, for example, from approximately 10 mM to 5M.

Collagen fibrillation may also be induced or enhanced with a nucleating agent other than salts. Nucleating agents provide a surface on which collagen monomers can come into close contact with each other to initiate fibrillation or can act as a branch point in which multiple fibrils are connected through the nucleating agent. Examples of suitable nucleating agents include but are not limited to: microgels containing collagen, collagen micro or nanoparticles, or naturally or synthetically derived fibers. Suitable nucleating agent concentrations may range from approximately 1 mM to 100 mM.

A collagen network may also be highly sensitive to pH. During the fibrillation step, the pH may be adjusted to control fibril dimensions such as diameter and length. The overall dimensions and organization of the collagen fibrils will affect the toughness, stretch-ability, and breathability of the resulting fibrillated collagen derived materials. This may be of use for fabricating fibrillated collagen derived leather for various uses that may require different toughness, flexibility, and breathability.

One way to control the organization of the dehydrated fibril network is to include filling materials that keep the fibrils spaced apart during drying. These filler materials could include nanoparticles, microparticles, microspheres, microfibers, or various polymers commonly used in the tanning industry. These filling materials could be part of the final dehydrated leather material, or the filling materials could be sacrificial, that is they are degraded or dissolved away leaving open space for a more porous fibril network.

The collagen or collagen-like proteins may be chemically modified to promote chemical and physical crosslinking between the collagen fibrils. Chemical crosslinking may be possible because reactive groups such as lysine, glutamic acid, and hydroxyl groups on the collagen molecule project from collagen's rod-like fibril structure. Crosslinking that involve these groups prevent the collagen molecules from sliding past each other under stress and thus increases the mechanical strength of the collagen fibers. Examples of chemical crosslinking reactions include but are not limited to reactions with the s-amino group of lysine, or reaction with carboxyl groups of the collagen molecule. Enzymes such as transglutaminase may also be used to generate crosslinks between glutamic acid and lysine to form a stable γ-glutamyl-lysine crosslink. Inducing crosslinking between functional groups of neighboring collagen molecules would be understood by one of ordinary skill in the art. Crosslinking is another step that can be implemented here to adjust the physical properties obtained from the fibrillated collagen hydrogel-derived materials.

Once formed, the fibrillated collagen network may be further stabilized by incorporating molecules with di-, tri-, or multifunctional reactive groups that include chromium, amines, carboxylic acids, sulfates, sulfites, sulfonates, aldehydes, hydrazides, sulfhydryls, diazarines, aryl-, azides, acrylates, epoxides, or phenols.

The fibrillated collagen network may also be polymerized with other agents (e.g. polymers that are capable of polymerizing or other suitable fibers) that form a hydrogel or have fibrous qualities, which could be used to further stabilize the matrix and provide the desired end structure. Hydrogels based upon acrylamides, acrylic acids, and their salts may be prepared using inverse suspension polymerization. Hydrogels described herein may be prepared from polar monomers. The hydrogels used may be natural polymer hydrogels, synthetic polymer hydrogels, or a combination of the two. The hydrogels used may be obtained using graft polymerization, crosslinking polymerization, networks formed of water soluble polymers, radiation crosslinking, and so on. A small amount of crosslinking agent may be added to the hydrogel composition to enhance polymerization.

Any appropriate thickness of the fibrillated collagen hydrogel may be made as described herein. Because the final thickness will be much less (e.g., between 10-90% thinner) than the hydrogel thickness, the initial hydrogel thickness may depend on the thickness of the final product desired, presuming the changes to the thickness (or overall volume) including shrinkage during tanning, dehydration and/or adding one or more oils as described herein. For example, the hydrogel thickness may be between 0.1 mm and 50 cm (e.g. between 0.1 mm and 20 mm, between a lower thickness of 0.05, 0.07, 0.1, 0.2, 0.3, 0.4, 0.5, 0.6, 0.7, 0.8, 0.9, 1, 2, 3, 4, 5, 6, 7, 8, 9, 10, 11, 12, 15, 20, etc. mm and an upper thickness of 0.5, 0.6, 0.7, 0.8, 0.9, 1, 2, 3, 4, 5, 6, 7, 8, 9, 10, 11, 12, 15, 20, 25, 30, 35, 40, 45, 50, etc. mm, where the lower thickness is always less than the upper thickness).

In forming the fibrillated hydrogel, the hydrogel may be incubated to form the thickness for any appropriate length of time, including between 1 min and 240 minutes (e.g. between a lower time in minutes of 1, 2, 3, 4, 5, 6, 7, 8, 9, 10, 15, 20, 25, 30, 35, 40, 45, 50, 55, 60, 65, 70, 75, 80, 85, 90, 95, 100, 105, 110, 120, etc. and an upper time in minutes of 5, 6, 7, 8, 9, 10, 15, 20, 25, 30, 35, 40, 45, 50, 55, 60, 65, 70, 75, 80, 85, 90, 95, 100, 105, 110, 120, 150, 180, 210, 240 etc.).

The fibrillated collagen hydrogels described herein may generally be formed in any appropriate shape and/or thickness, including flat sheets, curved shapes/sheets, cylinders, threads, and complex shapes. Further, virtually any linear size of these shapes. For example, any of these hydrogels may be formed into a sheet having a thickness as described and a length of greater than 10 mm (e.g., greater than, in mm, 15, 20, 25, 30, 35, 40, 45, 50, 55, 60, 65, 70, 75, 80, 85, 90, 95, 100, 200, 300, 400, 500, 600, 700, 800, 900, 1000, 1100, 1200, 1500, etc.) and width that is greater than 10 mm (e.g., greater than, in cm, 15, 20, 25, 30, 35, 40, 45, 50, 55, 60, 65, 70, 75, 80, 85, 90, 95, 100, 200, 300, 400, 500, 600, 700, 800, 900, 1000, 1100, 1200, 1500, etc.).

Once the hydrogel has been formed (or during formation), it may be tanned. For example, the fibrillated collagen hydrogel be treated with compounds containing chromium or aldehyde group, or vegetable tannins prior to gel formation, during gel formation, or after gel formation, to further stabilize the fibrillated collagen hydrogel. For example, collagen fibrils may be pre-treated with acrylic polymer followed by treatment with a vegetable tannin (e.g., Acacia mollissima) may exhibit increased hydrothermal stability. In other examples, glyceraldehyde may be used as a cross-linking agent that may increase the thermal stability, proteolytic resistance, and mechanical characteristics (e.g. Young's modulus, tensile stress) of the fibrillated collagen hydrogel.

The lack of higher-level organization of the fibrillated collagen hydrogels and leather material formed from them is apparent. Transmission electron micrographs and scanning electron micrographs both show the fibrillated collagen hydrogel as being a disordered tangle of collagen fibrils. As previously mentioned, the density and to some extent, the pattern of collagen fibril formation may be controlled by adjusting the pH of the collagen solution during fibrillation induction along with the concentration of fibrils during dehydration. In comparison with a natural bovine corium, the fibrillated collagen network is much more random and lacks the apparent striations. Although the overall size of the fibrils may be similar, the arrangement of these fibrils is quite different. Such ultrastructural differences between the collagen fibrils within the fibrillated collagen hydrogel and natural tissue such as bovine corium (and resulting leather made therefrom) may not be an issue in the final biofabricated leather product may be as soft or softer, and more pliable than natural leather, and may have a similar appearance.

The fibrillated collagen hydrogel may then be dehydrated to rid the fibrillated collagen hydrogel of the majority of its water content. Removing the water from the fibrillated collagen hydrogel may change its physical quality from a hydrated gel to a pliable sheet. The material may be treated to prevent breakage/tearing. For example, care may be taken not to remove too much water from the fibrillated collagen hydrogel. In some examples, it may be desirable to dehydrate the fibrillated collagen hydrogel to have a water content of less than 20%. (e.g., less than 15%, less than 10%, less than 9%, 8%, 7%, 6%, 5%, 4%, 3%, 2%, 1%, etc.) between 0.1% and 30%, between 0.1% and 20%, e.g., between a lower percent value of about 0.1, 0.2, 0.3, 0.4, 0.5, 0.6, 0.7, 0.8, 0.9, 1, 2, 3, 4, 5, 10, etc. and an upper percent value about 1, 2, 3, 4, 5, 6, 7, 8, 9, 10, 11, 12, 13, 14, 15, 16, 17, 18, 19, 20, 21, 22, 23, 24, 25, 30, etc., where the lower percent of water is always less than the upper percent of water).

Methods of dehydration include but are not limited to air drying, vacuum and pressure filtration, solvent exchange or a combination thereof. For example, fibrillated collagen hydrogel may undergo dehydration through replacement of its water content with organic solvents. Suitable organic solvents may include but are not limited to acetone, ethanol, and diethyl ether. Subsequently, the organic solvents may be evaporated (e.g. air drying, vacuum drying, etc.). It is also possible to perform successive steps of dehydration using one or more than one organic solvent to fine tune the level of dehydration in the final product.

After or during dehydration, the fibrillated collagen material may be treated with lubricants and/or oils to impart greater flexibility and suppleness to the fibrillated collagen material. Subsequently, the dehydrated fibrillated collagen hydrogel sheet is treated (fatliquored) with an oil and solvent solution. Using a combination of oil and solvent may allow the oil to better penetrate the fibrillated collagen network compared to using oil by itself. Oil by itself will only likely penetrate the exposed surfaces but may not readily infiltrate the entire thickness of the fibrillated collagen material in a reasonable amount of time. Once the oil/solvent composition has penetrated the entire thickness of the material, the solvent may then be removed. The resulting fibrillated collagen material has a leather-like appearance as compared to the dehydrated fibrillated collagen material prior to lubricant and/or oil treatment. Suitable oils and lubricants may include but are not limited to castor oil, pine oil, lanolin, mink oil, neatsfoot oil, fish oil, shea butter, aloe, and so forth.

Fatliquoring the dehydrated and tanned fibrillated collagen hydrogel to form a leather material may result in a material having properties that are similar, or better, than the properties of natural leather. Mass of the dehydrated fibrillated collagen material after treatment with various solutions of pure water (MilliQ water), acetone, 80/20 acetone/cod oil, ethanol, and 80/20 ethanol/castor oil was compared. The solutions that included a combination of oils and organic solvent increased the mass and the softness (inversely proportional to the slope of the stress-strain curve) of the dehydrated fibrillated collagen material. This is due to the combination of oils and organic solvents penetrating the dehydrated fibrillated collagen material and once penetrated through, the oils remained distributed throughout the material, while the organic solvents are able to evaporate away. The use of oils alone may not be as effective in penetrating entirely through the dehydrated fibrillated collagen material.

The resulting fibrillated collagen materials then may be treated similarly to natural leather derived from animal hide or skin, and be re-tanned, dyed, and/or finished. Additional processing steps may include: tanning, re-tanning, and surface coating. Tanning and re-tanning may include sub-processes such as wetting back (re-hydrating semi-processed leather), sammying (45-55% water is squeezed from the leather), splitting (leather is split into one or more layers), shaving (leather is thinned), neutralization (pH of leather is adjusted to between 4.5 and 6.5), dyeing (leather is colored), fat liquoring (fats, oils, waxes are fixed to the leather fibers), filling (dense/heavy chemicals to make leather harder and heavier), stuffing (fats, oils, waxes added between leather fibers), fixation (unbound chemicals are bonded/trapped and removed), setting (grain flatness are imparted and excess water removed), drying (leather is dried to desired moisture levels, 10-25%), conditioning (moisture is added to leather to a 18-28% level), softening (physical softening of leather by separating the fibers), or buffing (abrading surface of leather to reduce nap and grain defects). Surface coating may include any one or combination of the following steps: oiling (leather coated with raw oil or oils), buffing, spraying, roller coating, curtain coating, polishing, plating, embossing, ironing, or glazing.

As mentioned, a biofabricated leather material derived from the methods described above may have similar gross structural and physical characteristics as leathers produced from animal hides. In general, the biofabricated leather materials described herein may be derived from sources other than sheets or pieces of animal hide or skin, although animal hide or skin may be the source of the collagen used in preparing the fibrillated collagen. The source of the collagen or collagen-like proteins may be isolated from any animal (e.g. mammal, fish), or more particularly cell/tissue cultured, source (including in particular microorganism).

The biofabricated leather material may include agents that stabilize the fibril network contained therein or may contain agents that promote fibrillation. As mentioned in previous sections, cross-linking agents (to provide further stability), nucleating agents (to promote fibrillation), and additional polymerizing agents (for added stability) may be added to the collagen solution prior to fibrillation (or after) to obtain a fibrillated collagen material with desired characteristics (e.g. strength, bend, stretch, and so forth).

As mentioned, following dehydration, the engineered leather materials derived from the methods discussed above have a water content of less than 20% by weight. The water content of the engineered leather materials may be fine-tuned in the finishing steps to obtain leather materials for differing purposes and desired characteristics.

The biofabricated grain leather material shrinks upon dehydration or drying. The material may shrink from about 10% to about 99%, or from about 20% to about 80%, or from about 30% to about 70% in length, width and/or thickness based on the original length, width and thickness of the material prior to dehydration or drying.

As mentioned, any of these biofabricated leathers may be tanned (e.g., using a tanning agent including vegetable (tannins), chromium, alum, zirconium, titanium, iron salts, or a combination thereof, or any other appropriate tanning agent). Thus, in any of the resulting biofabricated leather materials described herein, the resulting material may include a percent (e.g., between 0.01% and 10%) of a residual tanning agent (e.g. tannin, chromium, etc.). Thus, the collagen fibrils in the resulting biofabricated leather material are modified to be tanned, e.g., cross-linked to resist degradation.

As mentioned above, in any of the variations for making the biofabricated leathers described herein, the material could be tanned (cross-linked) as the collagen is fibrillated and/or separately after fibrillation has occurred, prior to dehydration. For example, tanning may include crosslinking using an aldehyde (e.g., Relugan GTW) and/or any other tanning agent. Thus in general a tanning agent includes any collagen fibril cross-linking agent such as aldehydes cross linkers, chromium, amine, carboxylic acid, sulfate, sulfite, sulfonate, aldehyde, hydrazide, sulfhydryl, diazirine, aryl, azide, acrylate, epoxide, or phenol groups.

The dehydrated fibrillated collagen materials obtained are porous and the density of the collagen fibril network may be controlled through fibril dimensions and concentration or through the incorporation of filling materials. In general though, the collagen fibril network of the engineered leather materials lacks a higher order fiber or fiber bundle organization. This is not necessarily a disadvantage of the engineered leather materials described herein as leathers derived from animal hide are often processed in a manner that diminishes the highly ordered collagen bundles to produce desired leather characteristics that are then manufactured into leather goods. In some examples, the collagen fibril has a density approximately between 1 mg/cc to 1000 mg/cc. In other examples, the collagen fibrils have an approximate density of between 5 mg/cc and 500 mg/cc.

In general, the engineered leather materials have collagen fibrils of between 0.1 nm and 10 μm in diameter and have a length of between 10 nm and 5 mm. In some examples, the collagen fibrils may have fibril diameters of approximately 1 nm and 1 μm, and have fibril lengths of approximately between 100 nm and 1 mm.

In general, the biofabricated leather materials derived from fibrillated collagen hydrogels described herein may have good stretch, elasticity, and flexibility. The biofabricated leather materials described herein may have an elongation at breaking of between approximately 0% and 300% (e.g., between a lower percentage value of 0, 10, 20, 30, 40, 50, 60, 70, 80, 90, 100, 120, 140, 150, 160, 180, 200, etc. and an upper percentage value of 50, 60, 70, 80, 90, 100, 120, 140, 150, 160, 180, 200, 220, 240, 250, 260, 280, 300, etc., where the upper value is always greater than the lower value). In some examples, the engineered leather materials possess tensile strength of approximately between 1 MPa and 100 MPa. In some examples, the biofabricated leather materials possess an elastic modulus value of approximately between 1 kPa and 100 MPa.

One additional benefit of the biofabricated leather materials derived from fibrillated collagen described herein is the ability to control the thickness as well as the overall physical characteristics of the end product, as mentioned above. For the biofabricated leather material fabricated as described herein, the material may have a sheet thickness of between about 0.05 mm and 3.0 cm (e.g., between about 0.05 mm and 1 cm, or a minimum thickness in mm of between about 0.01, 0.02, 0.03, 0.05, 0.07, 0.08, 0.09, 0.1, 0.2, 0.3, 0.4, 0.5, 0.6, 0.7, 0.8, 0.9, 1, etc., and a maximum thickness in cm of about 0.1, 0.2, 0.3, 0.4, 0.5, 0.6, 0.7, 0.8, 0.9, 1, 1.5, 2.0, 2.5, 3.0, etc.), but any thickness of the biofabricated leather materials described herein can be made. Unlike animal hides, where the hide has to be trimmed to obtain the desired thickness or dimensions, the engineered leather material may be fabricated with a wide range of thicknesses as well as the desired dimensions with a particular end product in mind. The production of such engineered leather materials may also generate less waste by bypassing the step of removing excess proteins, fats, and hair necessary for treating natural animal hide in the leather production process, which results in less environmental impact from the disclosed process and the products derived from these methods. The thickness of the leather may be controlled through varying the total collagen as shown in Table 1 below. Each sample had a hydrated gel area of 525 cm².

TABLE 1

| | Gel | Gel | Gel | Total | Leather |
|---|---|---|---|---|---|
| | Density | Volume | Thickness | Collagen | Thickness |
| Sample | (g/L) | (L) | (cm) | (g) | (mm) |
| A | 5 | 0.8 | 1.5 | 4 | 0.1 |
| B | 9 | 0.8 | 1.5 | 7.2 | 0.2 |
| C | 9 | 1.6 | 3.0 | 14.4 | 1.1 |

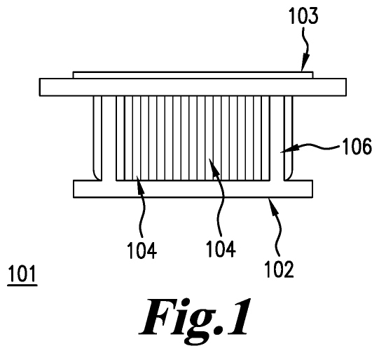

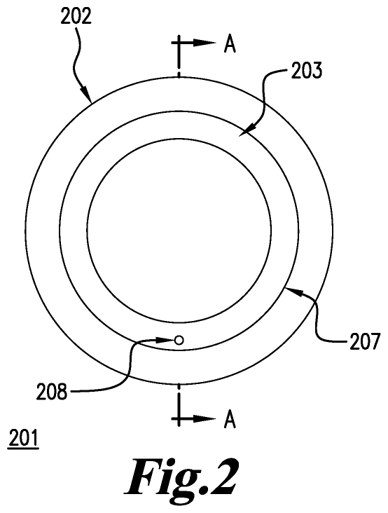

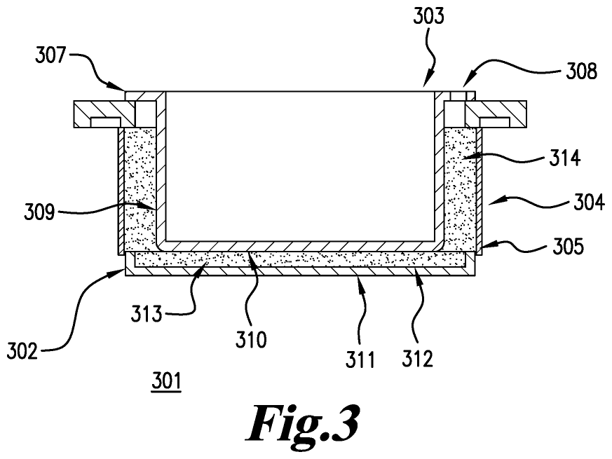

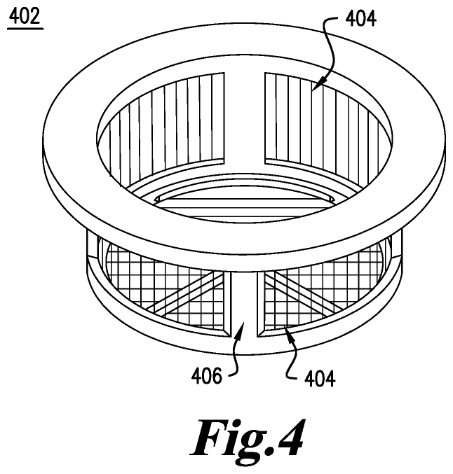

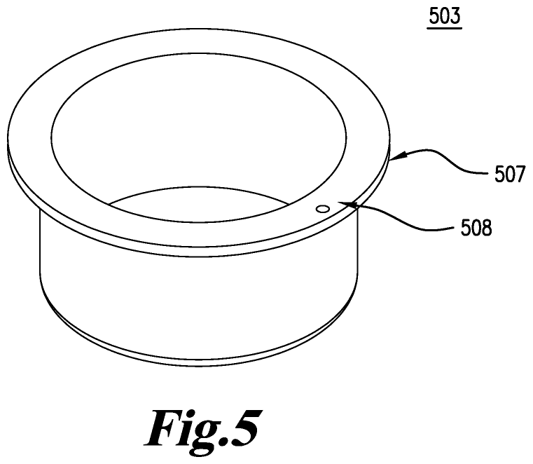

As mentioned above and as illustrated in FIG. 1, the present invention is related to an overall mold 101 comprising an outer, female mold 102 and an inner, male mold 103. The male mold 103 is inserted into the female mold 102 to create the overall mold 101. A mesh 104 is adhesively attached to a frame 106. As illustrated in FIG. 1 and FIG. 3, the female mold 102, 302 and the male mold 103, 303 are formed to generate a shaped biofabricated leather material. In an example, the shaped biofabricated leather material is a cup. FIG. 2 illustrates a top view of the female mold 202 and male mold 203 with a cross sectional line AA. A port 208 disposed on a lip 207 of the male mold 203 is used for administering a collagen concentrate into the female mold 202. FIG. 3 illustrates a cross sectional view of the female mold 302 and male mold 303 at cross sectional line AA. The female mold 302 has an outer bottom surface 311 and an inner bottom surface 312. The male mold 303 has a side surface 309, an outer bottom surface 310, a lip 307 that extends beyond the female mold 302, and a port 308 on the lip 307 for administering the collagen concentrate 305 into the female mold 302. The lip 307 retains the male mold 303 such that there is a gap 313 between the outer bottom surface 310 of the male mold 303 and inner bottom surface 312 of the female mold 302, when the male mold 303 is shorter than the female mold 302. The gap 313 may range from about 1 mm to about 1 inch. The male mold 303 has a smaller diameter than the female mold 302 such that when the male mold 303 is inserted in the female mold 302 there is a gap 314 between the two molds. The gap 314 may range from about 1 mm to about 1 inch. The difference in the diameters may determine the thickness of the gap 314 and the product made from the mold 301. FIG. 4 is a perspective view of the female mold 402 having a mesh 404 adhesively attached to the frame 406. The mesh 404 is adhesively attached to the frame 406 of the female mold 402. FIG. 5 is a perspective view of the male mold 503 illustrating the port 508 on the lip 507 of the overall mold.

The following are merely exemplary embodiments of the present disclosure, and should be considered nonlimiting. Therefore, the scope of the invention should not be limited to the details therein.

### Collagen Procurement

A solution of collagen was made with purchased Bovine collagen. This source of collagen is type I collagen isolated from bovine tendon by acid treatment followed by pepsin digestion and purified by size exclusion chromatography, frozen and lyophilized. The lyophilized protein (10 grams) was dissolved in 1 liter of 0.01N HCl, pH 2 using an overhead mixer. After the collagen was adequately dissolved, as evidenced by a lack of solid collagen sponge in the solution (at least 1 hr mixing at 1600 rpm), 111.1 ml of 200 mM sodium phosphate (pH adjusted to 11.2 with sodium hydroxide) was added to raise the pH of the solution to 7.2. The resulting collagen solution was stirred for 10 minutes and 0.1 ml of a 20% Relugan GTW (BASF) crosslinker (tanning agent) solution, which was 2% of the weight of the collagen, was added. 5 mL of 20% Tanigan FT (Lanxess) was added to the crosslinked collagen fibril solution and stirred for one hour. Following Tanigan-FT addition, 1 gram of microspheres (10% on the weight of collagen), 40 mL (80% on the weight of collagen) of Truposol Ben (Trumpler) and 2 mL (10% on the weight of collagen) of PPE White HS a pa (Stahl) were added and stirred for an hour using an overhead stirrer. The pH of the solution was reduced to 4.0 using 10% formic acid and stirred for an additional hour.

### Example 1

A solution of collagen, as described above, was obtained. A female mold, as shown in FIG. 1 through FIG. 4, was made using polyethylene terephthalate (PET) polymer via 3D printer (Zortrax M200). The 3D printed PET polymer female mold was in the shape of a cylinder having a bottom. The dimensions of the female mold are 3 inches in diameter by 1 inch in height by ⅛ inch in thickness. A mesh (200×200 stainless steel woven mesh; McMaster-Carr) was attached with epoxy to the bottom and sides of the frame. A male mold, as shown in FIG. 1 and FIG. 2, was similarly made using PET polymer via 3-D printer (Zortrax M200). The 3D printed PET polymer male mold was in the shape of a cylinder having a bottom. The dimensions of the male mold are 2.7 inches in diameter by 1 inch in height by ⅛ in thickness. A 100 mL pipette was used to fill the bottom of the female mold with the collagen solution described above. Once the mold was filled to a ¼ inch height, the male mold was placed on top of the collagen solution. Supplemental collagen solution was added to fill the void between the male mold and the female mold. A vacuum was then applied, thereby removing water from the collagen solution. As water is removed, the height of the liquid drops, breaking the vacuum. Additional collagen solution was added to cover and reseal the mesh area. This process was repeated as required to maintain vacuum and fill the mold. After 10 minutes of dewatering by the vacuum, the mold was removed from the vacuum and placed in a fume hood to allow the article to continue to dry. The mold was placed upside down to dry at room temperature for 12 hours in order to maximize the exposure of the female mesh area. The male mold was then removed and the article inside the female mold was allowed to continue to dry upside down at room temperature for an additional 6 hours. The article was then removed from the female mold, resulting in a molded bioleather article.

### Example 2

A solution of collagen, as described above, was obtained and blended at 60° C. with polycaprolactone (50:50 by weight). A left mold and a right mold were made from steel. The left mold contains an outer surface and a concave inner surface. The right mold contains an outer surface and a convex inner surface with a port extending from the outer to the inner surface. The molds were tooled to have a cavity in the shape of a horse saddle and include ejection pins. The molds are mechanically held together and heated to 60° C. The collagen solution is fed through an extruder to fill the cavity between the left and right mold. The molds are held at 60° C. for 1 minute and then allowed to cool to room temperature. Once cooled the left and right molds are separated and the ejection pins are utilized to release the sample from the molds.

### Example 3

A solution of collagen, as described above, was obtained and blended at 60° C. with polycaprolactone (50:50 by weight). The warmed mixture is distributed on a surface to achieve an ⅛-inch thickness, then dried and cooled into a sheet for thermoforming. The dried and cooled sheet is then placed on a Formech thermoforming machine having a mold in the shape of a snowman. The sheet is heated to 60° C. The snowman mold is pushed up into the sheet and a vacuum is created in order to form the sheet onto the surface of the snowman mold. The shaped sheet and the mold are then cooled to room temperature and the shaped sheet is removed from the surface of the snowman mold.

### Example 4

A solution of collagen, as described above, was obtained and blended at 60° C. with polycaprolactone (50:50 by weight). The warmed mixture is poured into a mold and a vacuum is applied to remove water. The sheet is then dried and cooled to room temperature. The dried and cooled sheet is placed on a Maac Machinary thermoforming machine having a mold in the shape of a rose. The sheet is heated to 60° C. The mold is pushed up into the sheet and vacuum is pulled to form the sheet onto the surface of the mold. The shaped sheet and the mold are cooled to room temperature. The shaped sheet is removed from the surface of the mold.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A three-dimensionally shaped article comprising extracted naturally occurring collagen, recombinant collagen, or a combination therein.

2. The shaped article of claim 1, wherein the recombinant collagen is Type III collagen.

3. The shaped article of claim 1, wherein the recombinant collagen is selected from a group of sources including bovine, pig, kangaroo, sheep, alligator, ostrich, dinosaur, elephant, crocodile, mammoth, antelope, bear, beaver, bison, boar, camel, caribou, cat, cattle, deer, dog, elk, fox, giraffe, goat, hare, horse, ibex, lion, llama, lynx, mink, moose, oxen, peccary, rabbit, seal, squirrel, tiger, whale, wolf, yak, zebra, turtle, snake, frog, toad, salamander, newt, chicken, duck, emu, goose, grouse, pheasant, pigeon, quail, turkey, fish or a combination thereof.

4. The shaped article of claim 1, wherein the shape of the article is selected from the group consisting of a sphere, a cylinder, a cone, a cube, a tetrahedron, a cuboid, a triangular prism, and combinations thereof.

5. A method of forming a three dimensionally shaped article, the method comprising: providing a solution of collagen, providing a male mold and a female mold having a shaped cavity wherein the female mold contains a material that enables water to be removed via vacuum, filling the female mold partially with the collagen solution, inserting the male mold into the female mold, filling the void between the female mold and male mold with the collagen solution, pulling vacuum on the molds, repeating the filling and vacuum process until the void is filled, drying the article, and removing the article from the molds to form the three dimensionally shaped collagen article.

6. The method of claim 5, wherein the solution of collagen comprises extracted naturally occurring collagen, recombinant collagen, or a combination therein.

7. The method of claim 6, wherein the recombinant collagen is Type III collagen.

8. The method of claim 6, wherein the recombinant collagen is selected from a group of sources including bovine, pig, kangaroo, sheep, alligator, ostrich, dinosaur, elephant, crocodile, mammoth, antelope, bear, beaver, bison, boar, camel, caribou, cat, cattle, deer, dog, elk, fox, giraffe, goat, hare, horse, ibex, lion, llama, lynx, mink, moose, oxen, peccary, rabbit, seal, squirrel, tiger, whale, wolf, yak, zebra, turtle, snake, frog, toad, salamander, newt, chicken, duck, emu, goose, grouse, pheasant, pigeon, quail, turkey, fish or a combination thereof.

9. The method of claim 5, wherein the mold is made from a material selected from the group consisting of polyethylene, polyethylene terephthalate, polypropylene, polycarbonate, aluminum, fiber glass, stainless steel and combinations thereof.

10. The method of claim 5, wherein the shape of a surface of the cavity is selected from the group consisting of round, curved, square, elliptical and combinations thereof.

11. The method of claim 5, wherein the material in the female mold that enables water to be removed via vacuum is a mesh material.

12. The method of claim 11, wherein the mesh material has openings of no greater than 74 microns.

13. The method of claim 5, wherein the three dimensionally shaped collagen article is dried at room temperature.

14. A method of forming a three dimensionally shaped collagen article, the method comprising: providing a heated solution of collagen and a polymer, providing a left and a right mold that are tooled to have a cavity, a port and means to remove the article, holding the molds together, heating the molds, providing a means to feed the collagen solution through the port and to fill the cavity, allowing the mold and article to cool, opening the molds, and releasing the article from the molds to form the shaped collagen article.

15. The method of claim 14, wherein the polymer is a thermoplastic polymer.

16. The method of claim 15, wherein the thermoplastic polymer is polycaprolactone.

17. The method of claim 14, wherein the solution of collagen comprises extracted naturally occurring collagen, recombinant collagen, or a combination therein.

18. The method of claim 17, wherein the recombinant collagen is Type III.

19. The method of claim 17, wherein the recombinant collagen is selected from a group of sources including bovine, pig, kangaroo, sheep, alligator, ostrich, dinosaur, elephant, crocodile, mammoth, antelope, bear, beaver, bison, boar, camel, caribou, cat, cattle, deer, dog, elk, fox, giraffe, goat, hare, horse, ibex, lion, llama, lynx, mink, moose, oxen, peccary, rabbit, seal, squirrel, tiger, whale, wolf, yak, zebra, turtle, snake, frog, toad, salamander, newt, chicken, duck, emu, goose, grouse, pheasant, pigeon, quail, turkey, fish or a combination thereof.

20. The method of claim 14, wherein the mold is made from a material selected from the group consisting of aluminum, stainless steel and combinations thereof.

21. The method of claim 14, wherein the shape of a surface of the cavity is selected from the group consisting of round, curved, square, elliptical and combinations thereof.

22. The method of claim 14, wherein the means to feed the collagen solution through the port is selected from the group consisting of an extruder, a pump and combinations thereof.

23. The method of claim 14, wherein the molds are heated up to a temperature in the range of about 40° C. to 80° C.

24. The method of claim 14, wherein after the molds are filled, they are cooled to room temperature.

25. The method of claim 14, wherein the means to remove the article is selected from the group consisting of ejection pins, spray coatings, and combinations thereof.

26. A method of forming a three dimensionally shaped collagen article, the method comprising: providing a heated solution of collagen and a polymer, providing a mold, forming the collagen solution into a sheet, heating the sheet, forming the sheet onto the mold, cooling the molded sheet and removing the molded sheet from the mold to form the shaped collagen article.

27. The method of claim 26, wherein the polymer is a thermoplastic polymer.

28. The method of claim 27, wherein the thermoplastic polymer is polycaprolactone.

29. The method of claim 26, wherein the solution of collagen comprises extracted naturally occurring collagen, recombinant collagen, or a combination therein.

30. The method of claim 29, wherein the recombinant collagen is Type III.

31. The method of claim 29, wherein the recombinant collagen is selected from a group of sources including bovine, pig, kangaroo, sheep, alligator, ostrich, dinosaur, elephant, crocodile, mammoth, antelope, bear, beaver, bison, boar, camel, caribou, cat, cattle, deer, dog, elk, fox, giraffe, goat, hare, horse, ibex, lion, llama, lynx, mink, moose, oxen, peccary, rabbit, seal, squirrel, tiger, whale, wolf, yak, zebra, turtle, snake, frog, toad, salamander, newt, chicken, duck, emu, goose, grouse, pheasant, pigeon, quail, turkey, fish or a combination thereof.

32. The method of claim 26, wherein the material for the mold is selected from the group consisting of polyethylene, polyethylene terephthalate, polypropylene, polycarbonate, aluminum, fiber glass, stainless steel and combinations thereof.

33. The method of claim 26, wherein the shape of a surface of the mold is selected from the group consisting of round, curved, square and elliptical.

34. The method of claim 26, wherein the sheet is made by spreading the solution onto a surface to a desired thickness and drying and cooling the sheet.

35. The method of claim 26, wherein the sheet is made by pouring the solution into a mold, applying vacuum to remove water, and drying and cooling the sheet.

36. The method of claim 26, wherein the sheet is heated up to a temperature in the range of about 35° C. to 60° C.

37. The method of claim 26, wherein the molded sheet is cooled to room temperature.
